(19) United States
(12) Patent Application Publication
(10) Pub. No.: US 2009/0174781 A1
(43) Pub. Date: Jul. 9, 2009

(54) ELECTRONIC EQUIPMENT AND IMAGE PICKUP APPARATUS

(75) Inventor: Koji AMEMIYA, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/347,526

(22) Filed: Dec. 31, 2008

(30) Foreign Application Priority Data
Jan. 7, 2008 (JP) 2008-000329

(51) Int. Cl. H04N 5/225; H04N 5/228

(52) U.S. Cl. 348/207.1; 348/222.1; 348/333.01; 348/E05.031; 348/E05.024

(57) ABSTRACT

An image pickup apparatus of the present invention can be operated in any operation mode selected from a plurality of operation modes including a particular operation mode and other operation modes. The image pickup apparatus includes a display unit that displays information for controlling the apparatus, and a control unit that switches the operation mode of the apparatus. When the control unit switches the operation mode between one of the other operation modes and the particular operation mode, the control unit causes the display unit to provide a display for prompting a user to give an instruction on whether to permit switching of the operation mode, before switching of the operation mode. When the control unit switches the operation mode between the other operation modes, the control unit causes the apparatus to be operated in an operation mode after switching without allowing the display unit to provide a display for prompting the user to give an instruction. Due to such a configuration, the inconvenience of the usability, such as a long period of time needed for activating an operation mode, can be prevented.

### BACKGROUND OF THE INVENTION

1. Field of the Invention

The present invention relates to electronic equipment that is capable of selecting a plurality of operation modes and that is operated in any one of the operation modes. The present invention is applicable to, for example, an image pickup apparatus with a wireless communication function and a display apparatus with a television broadcast receiving function.

2. Description of Related Art

In recent years, a digital camera with a wireless communication function capable of being connected to a wireless network such as a wireless local area network (LAN) has been developed. Due to the presence of a wireless communication function in a digital camera, image data generated in the digital camera, image data recorded on a recording medium in the digital camera, and the like easily can be transferred to a computer, a printer, etc.

JP 2007-20042 A discloses an electronic camera with a wireless communication function. The electronic camera includes a mode dial for switching the operation mode of the electronic camera as part of a manipulation portion. The mode dial can shift the operation mode of the electronic camera to a wireless LAN mode. When the operation mode of the electronic camera is shifted to the wireless LAN mode by the mode dial, the electronic camera displays a profile list screen on a liquid crystal display provided therein. The electronic camera prohibits the supply of electric power to a wireless LAN module portion therein until a connection destination of the electronic camera is selected on the profile list screen by a user. When a connection destination of the electronic camera is selected on the profile list screen, the electronic camera permits the supply of electric power to the wireless LAN module portion. Thus, in the electronic camera capable of transferring image data to a computer or a printer to be connected via a wireless network, unnecessary power consumption can be suppressed.

However, in the conventional electronic camera, when the mode dial is manipulated and the operation mode is shifted to the wireless LAN mode once, the profile list screen is displayed on the liquid crystal display. A user needs to manipulate the manipulation portion while watching the profile list screen displayed on the liquid crystal display, set the connection destination on the wireless network, and the like.

As described above, in order to transmit/receive image data via the wireless network, cumbersome manipulations are required, such as the setting and registration between pieces of equipment to be connected to the wireless network and the designation of image data to be transmitted. Furthermore, in the conventional electronic camera, it takes a long period of time from a time when the user manipulates the mode dial to select a wireless communication mode and activates the wireless communication module portion to a time when the state is shifted to the one in which the wireless communication actually can be performed.

Accordingly, when the electronic camera enters a particular operation mode (for example, the above-mentioned wireless LAN mode), cumbersome manipulations and time-consuming manipulations may be required. Therefore, when the manipulation for shifting to a particular operation mode (hereinafter, referred to as a shift manipulation) and the manipulation for coming out of a particular operation mode (hereinafter, referred to as an end manipulation) needs to be repeated due to the error of the user or the like, cumbersome manipulations are required every time the shift manipulation and the end manipulation are performed. Furthermore, it takes a long period of time from a time when the shift manipulation is performed to a time when the operation mode actually is shifted to a particular operation mode, and from a time when the end manipulation is performed to a time when the electronic camera comes out of a particular operation mode, which degrades the usability.

### SUMMARY OF THE INVENTION

Therefore, with the foregoing in mind, it is an object of the present invention to provide an image pickup apparatus capable of reducing the inconvenience of the usability at a time of switching of an operation mode, and electronic equipment using the same.

A first configuration of an image pickup apparatus of the present invention includes: a mode switching unit that receives a manipulation for selecting one operation mode from a plurality of operation modes including a particular operation mode and other operation modes; a display unit capable of displaying information for controlling the image pickup apparatus; and a control unit that switches the operation mode of the image pickup apparatus in accordance with the manipulation received by the mode switching unit. When the mode switching unit receives a manipulation for switching from one of the other operation modes to the particular operation mode and/or when the mode switching unit receives a manipulation for switching from the particular operation mode to one of the other operation modes, the control unit causes the display unit to provide a display for prompting a user to give an instruction on whether to permit switching of the operation mode, before the control unit switches the operation mode.

A second configuration of an image pickup apparatus of the present invention includes: a mode switching unit that receives a manipulation for selecting one operation mode from a plurality of operation modes including a particular operation mode and other operation modes; a display unit capable of displaying information for controlling the image pickup apparatus; and a control unit that switches the operation mode of the image pickup apparatus in accordance with the manipulation received by the mode switching unit. When the mode switching unit receives a manipulation for switching from the particular operation mode to one of the other operation modes, the control unit causes the display unit to provide a display for prompting the user to give an instruction on whether to permit switching of the operation mode, before the control unit switches the operation mode, and when the mode switching unit receives a manipulation for switching from one of the other operation modes to the particular operation mode while the display unit provides the display for prompting the user to give an instruction on whether to permit switching of the operation mode, the control unit erases the display on the display unit.

A first configuration of electronic equipment of the present invention includes: a mode switching unit that receives a manipulation for selecting one operation mode from a plurality of operation modes including a particular operation mode and other operation modes; a display unit capable of displaying information for controlling the electronic equipment; and a control unit that switches the operation mode of the electronic equipment in accordance with the manipulation received by the mode switching unit. When the mode switching unit receives a manipulation for switching from one of the other operation modes to the particular operation mode and/or when the mode switching unit receives a manipulation for switching from the particular operation mode to one of the other operation modes, the control unit causes the display unit to provide a display for prompting a user to give an instruction on whether to permit switching of the operation mode, before the control unit switches the operation mode.

A second configuration of electronic equipment of the present invention includes: a mode switching unit that receives a manipulation for selecting one operation mode from a plurality of operation modes including a particular operation mode and other operation modes; a display unit capable of displaying information for controlling the electronic equipment; and a control unit that switches the operation mode of the electronic equipment in accordance with the manipulation received by the mode switching unit. When the mode switching unit receives a manipulation for switching from the particular operation mode to one of the other operation modes, the control unit causes the display unit to provide a display for prompting a user to give an instruction on whether to permit switching of the operation mode, before the control unit switches the operation mode, and when the mode switching unit receives a manipulation for switching from one of the other operation modes to the particular operation mode while the display unit provides the display for prompting the user to give an instruction on whether to permit switching of the operation mode, the control unit erases the display on the display unit.

According to the present invention, even when a manipulation for a shift to an operation mode (in which it takes a long period of time for activation processing) and/or a manipulation for coming out of an operation mode (in which it takes a long period of time for end processing) are performed repeatedly due to the error of a user or the like, an operation mode is not switched immediately. Thus, the inconvenience caused when an operation mode is switched can be reduced.

### BRIEF DESCRIPTION OF THE DRAWINGS

FIG. 1 is a block diagram showing a configuration of a digital camera according to an embodiment of the present invention.

FIG. 2 is a perspective view of the digital camera according to the embodiment of the present invention.

FIG. 3 is a perspective view of the digital camera according to the embodiment of the present invention.

FIG. 4 is a top view of the digital camera according to the embodiment of the present invention.

FIG. 5 is a flowchart illustrating a mode switching operation of the digital camera according to the embodiment of the present invention.

FIG. 6 is a schematic view showing an example of a display for prompting a user to give an instruction.

FIG. 7 is a schematic view showing a configuration of data stored in a flash memory and a buffer memory.

FIG. 8 is a flowchart illustrating a shift operation to a wireless LAN mode.

FIG. 9 is a schematic view showing an example of a display for prompting the user to give an instruction.

FIG. 10 is a schematic view showing a display example of a wireless LAN communication menu.

FIG. 11 is a schematic view showing a display example of an access point list.

FIG. 12 is a schematic view of a screen to be displayed during a wireless LAN connection.

FIG. 13 is a schematic view of a screen to be displayed during the wireless LAN connection.

FIG. 14 is a flowchart illustrating a shift operation from the wireless LAN mode to another operation mode.

FIG. 15 is a schematic view showing an example of a display for prompting the user to give an instruction.

FIG. 16 is a schematic view showing an example of a password input screen.

### DETAILED DESCRIPTION OF THE INVENTION

An image pickup apparatus and electronic equipment of the present invention can have the following embodiment based on the above-mentioned configuration.

More specifically, in the image pickup apparatus and the electronic equipment of the present invention, when the mode switching unit receives a manipulation for switching between the other operation modes, the control unit causes the apparatus and equipment to be operated in an operation mode before switching of the mode switching unit without allowing the display unit to provide a display for prompting the user to give an instruction.

The image pickup apparatus and the electronic equipment of the present invention further include a receiving unit that receives an instruction of the user for permitting switching of the operation mode, wherein, after the control unit causes the display unit to provide a display for prompting the user to give an instruction on whether to permit switching of the operation mode, the control unit causes the apparatus and equipment to be operated in an operation mode before switching of the mode switching unit until the receiving unit receives the instruction of the user.

In the image pickup apparatus and electronic equipment of the present invention, when the mode switching unit receives a manipulation for switching from one of the other operation modes to the particular operation mode and/or when the mode switching unit receives a manipulation for switching from the particular operation mode to one of the other operation modes, the control unit causes the display unit to provide a display for prompting the user to give an instruction on whether to permit switching of the operation mode and prohibits the display unit from providing a display for prompting the user to give an instruction for not permitting switching of the operation mode, before switching of the operation mode.

The image pickup apparatus and the electronic equipment of the present invention further include: a first storage unit that stores a control program for controlling the particular operation mode; a reading unit that reads the control program from the first storage unit; and a second storage unit that is capable of storing the control program read by the reading unit and being accessible at a higher speed than that of the first storage unit, wherein the reading unit reads the control program from the first storage unit when the control unit switches the operation mode from one of the other operation modes to the particular operation mode.

In the image pickup apparatus and the electronic equipment of the present invention, the mode switching unit is a dial.

In the image pickup apparatus and the electronic equipment of the present invention, the particular operation mode is a wireless communication mode.

### Embodiment

### 1. Configuration of Electronic Equipment

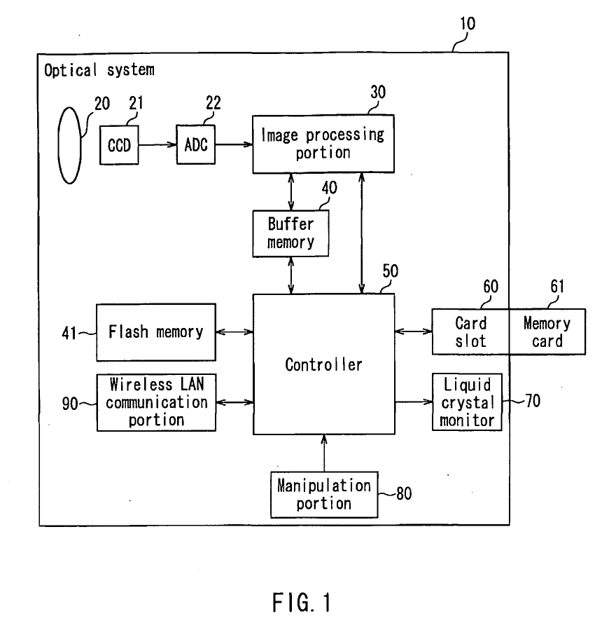

FIG. 1 is a block diagram showing a configuration of a digital camera 10 according to an embodiment of the present invention. As shown in FIG. 1, the digital camera 10 of the present embodiment includes an optical system 20, a charge coupled device (CCD) image sensor 21, an analog/digital converter 22, an image processing portion 30, a buffer memory 40, a flash memory 41, a controller 50, a card slot 60, a liquid crystal monitor 70, a manipulation portion 80, and a wireless LAN communication portion 90.

The optical system 20 collects light from a subject to form a subject image on an image pickup plane of the CCD image sensor 21. The CCD image sensor 21 is an image pickup element that picks up a subject image to generate an image signal. In the present embodiment, although the CCD image sensor 21 is adopted as the image pickup element, a complementary metal oxide semiconductor (CMOS) image sensor or the like also can be used in place of the CCD image sensor 21. The analog/digital converter (hereinafter, referred to as an AD converter) 22 digitally converts the image signal generated by the CCD image sensor 21.

The image processing portion 30 subjects the image data digitized by the AD converter 22 to predetermined processing. The predetermined processing includes gamma transformation, YC transformation, electron zooming, compression, and decompression. The gamma transformation is to adjust the degree of lightness and darkness of an image. The YC transformation is to separate an image into a luminance signal and a color signal. The electron zooming is to trim a part of an image and interpolate pixels to enlarge the size of the image, or thin out a vertical line and a horizontal line of the image to reduce the size thereof. The compression is to compress image data based on an image format standard such as Joint Photographic Expert Group (JPEG). The decompression is to decompress compressed image data. The predetermined processing of the present embodiment is not limited to the above processing.

The buffer memory 40 is capable of storing image data, a control signal, and the like temporarily (work memory) when the image processing portion 30 performs image processing and when the controller 50 performs control processing. The buffer memory 40 can be realized by, for example, dynamic random access memory (DRAM).

The flash memory 41 is a built-in memory capable of storing image data. The flash memory 41 is capable of storing a program, a set value, and the like for controlling the controller 50 in addition to the image data.

The controller 50 controls the entire digital camera 10. The controller 50 may be realized by a microcomputer or a hard-wired circuit, as long as at least the entire digital camera 10 can be controlled.

The card slot 60 is a slot for attaching/detaching the memory card 61. The card slot 60 may have a function of controlling the write and read of information with respect to the memory card 61. The memory card 61 stores a flash memory and the like. The memory card 61 is capable of storing image data and the like generated when the digital camera 10 performs a photographing operation.

The liquid crystal monitor 70 can display an image based on image data generated by the digital camera 10, an image based on image data stored in the memory card 61, various pieces of setting information of the digital camera 10, and the like. The liquid crystal monitor 70 is an example of a display unit of the present invention, and an organic electronic luminescence (EL) display or the like also can be mounted on the digital camera 10, in place of the liquid crystal monitor 70.

The manipulation portion 80 is a generic identification for manipulation members placed in an outer housing of the digital camera 10. The manipulation portion 80 includes a cursor key, a press button, and the like.

The wireless LAN communication portion 90 can perform bidirectional communication via a wireless LAN, and is composed of an antenna circuit, a modulation circuit, a demodulation circuit, and the like. The wireless LAN communication portion 90 is an example of a communication unit in the present invention. Although the wireless LAN communication portion 90 is modularized in most cases, the wireless LAN communication portion 90 can be a part of the controller 50.

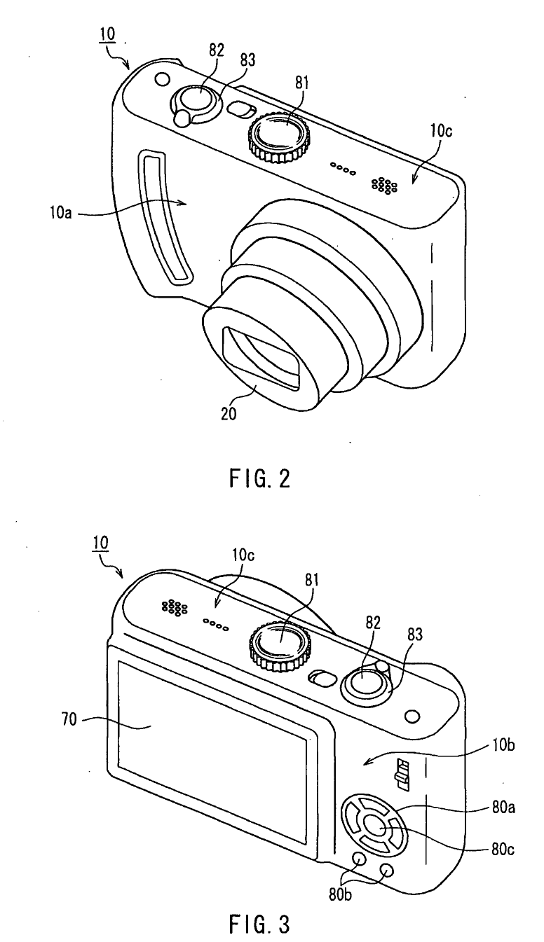

FIGS. 2 and 3 are perspective views showing an outer appearance of the digital camera 10. FIG. 2 shows a front surface side of the digital camera 10. FIG. 3 shows a back surface side of the digital camera 10. In the context of the present embodiment, the “front surface of the digital camera 10” refers to the surface opposed to a subject when the digital camera 10 is photographing the subject. Furthermore, the “back surface of the digital camera 10” refers to the surface opposed to a photographer when the digital camera 10 is photographing a subject. As shown in FIG. 2, the optical system 20 is placed on a front surface 10a of the digital camera 10. As shown in FIG. 3, a cursor button 80a and press buttons 80b that are examples of the manipulation portion 80 (see FIG. 1), and the liquid crystal monitor 70 are placed on a back surface 10b of the digital camera 10.

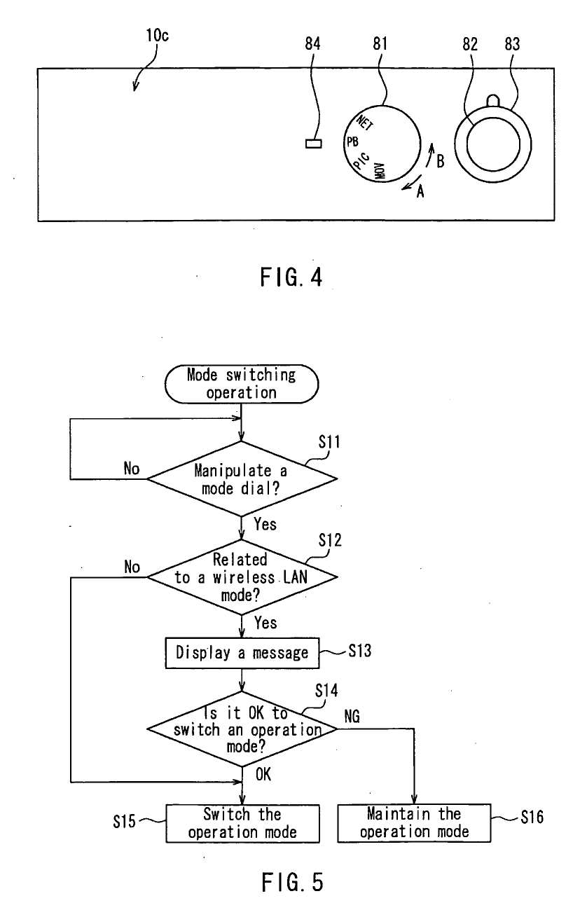

FIG. 4 is a top view of the digital camera 10. As shown in FIGS. 2 to 4, a mode dial 81, a release button 82, and a zoom lever 83 are placed on a top surface 10c of the digital camera 10.

The mode dial 81 receives a manipulation for switching the operation mode of the digital camera 10. The digital camera 10 is assigned a plurality of operation modes including a wireless LAN mode. More specifically, the mode dial 81 can receive a manipulation for selecting one operation mode from the plurality of operation modes including the wireless LAN mode. When the mode dial 81 is rotated in a direction indicated by an arrow A or B by a user, and a symbol corresponding to an arbitrary operation mode described on the upper surface of the mode dial 81 is positioned at a reference mark 84, the controller 50 receives a manipulation for switching an operation mode by the mode dial 81. More specifically, the controller 50 switches the operation mode of the digital camera 10 in accordance with the manipulation received by a mode switching unit (mode dial 81 in the present embodiment). Furthermore, the mode dial 81 is an example of the mode switching unit in the present invention. In the present embodiment, the operation modes selectable by the mode dial 81 are a still picture photographing mode (“PIC” in FIG. 4), a playback mode (“PB” in FIG. 4), a moving video photographing mode (“MOV” in FIG. 4), and a wireless LAN mode (“NET” in FIG. 4). The operation modes selectable by the mode dial 81 are not limited to the four kinds of operation modes shown in FIG. 4.

When the user rotates the mode dial 81 to select the “wireless LAN mode”, the controller 50 prompts the user to give an instruction on whether to activate the wireless LAN mode. Then, when the user gives an instruction for activating the wireless LAN mode, the controller 50 activates the wireless LAN mode. The wireless LAN mode enables wireless communication with external apparatuses such as a computer and a printer through the wireless LAN communication portion 90.

Furthermore, when the user rotates the mode dial 81 to select the “playback mode”, the controller 50 reads image data stored in the memory card 61 or the flash memory 41 and displays an image based on the image data on the liquid crystal monitor 70.

Furthermore, when the user rotates the mode dial 81 to select the “still picture photographing mode”, the controller 50 stores image data on the still picture photographed by the CCD image sensor 21 and generated by the image processing portion 30 in the memory card 61 or the flash memory 41.

Furthermore, when the user rotates the mode dial 81 to select the “moving video photographing mode”, the controller 50 stores image data on the moving video photographed by the CCD image sensor 21 and generated by the image processing portion 30 in the memory card 61 and the flash memory 41.

In the present embodiment, although the digital camera 10 having the “wireless LAN mode”, “playback mode”, “still picture photographing mode”, and “moving video photographing mode” is illustrated, the present invention is not limited thereto. For example, the digital camera 10 may have another operation mode. Even in the case where the digital camera 10 lacks a part of the four operation modes, the present invention is applicable. That is, any electronic equipment that has a plurality of operation modes and prompts a user to give an instruction when switching an operation mode included in the plurality of operation modes is included in the scope of the present invention.

In the digital camera 10 configured as described above, the switching of the operation mode based on the rotation of the mode dial 81 will be described.

### 2. Operation During Mode Switching

### 2-1. Basis Operation

FIG. 5 is a flowchart illustrating a flow of an operation control by the controller 50 during mode switching by the mode dial 81.

The controller 50 monitors the rotation of the mode dial 81, and determines whether or not mode switching has been performed by the mode dial 81 (S11).

When the controller 50 detects that a user has switched an operation mode by rotating the mode dial 81, the controller 50 determines whether or not the rotation is related to a wireless LAN mode (S12). For example, in FIG. 4, when the mode dial 81 is switched from the “NET” to the “PB” or from the “PB” to the “SET”, the controller 50 determines that the rotation is related to the wireless LAN mode. In contrast, when the mode dial 81 is switched between the “PB” and the “PIC” or between the “PIC” and the “MOV”, the controller 50 determines that the rotation is not related to the wireless LAN mode.

Referring to FIG. 5 again, when the controller 50 determines that the rotation of the mode dial 81 is related to the wireless LAN mode (that is, in the case where the mode dial 81 receives an instruction for switching between the wireless LAN mode and another mode), the controller 50 causes the liquid crystal monitor 70 to provide a display for prompting the user to give an instruction on whether to permit the switching to the operation mode indicated by the switching (S13).

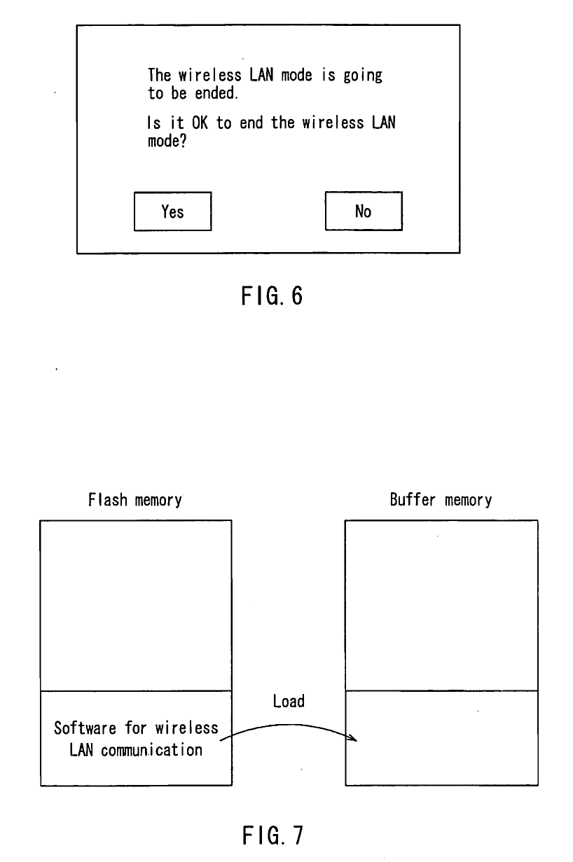

The “display for prompting the user to give an instruction” is, for example, a display screen shown in FIG. 6. The display screen shown in FIG. 6 is displayed, for example, when the mode dial 81 receives a manipulation for switching from the wireless LAN mode to the playback mode. When the display screen shown in FIG. 6 is displayed on the liquid crystal monitor 70, the user manipulates the manipulation portion 80 to select whether or not to permit the switching to the operation mode selected by the mode switching unit.

Next, when the user permits the switching to the operation mode indicated by the mode switching, the controller 50 controls each portion in the digital camera 10 so that the digital camera 10 is operated in the operation mode after the mode switching received by the mode dial 81 (S15).

On the other hand, when the user denies the switching to the operation mode indicated by the mode switching, the controller 50 controls each portion in the digital camera 10 in the operation mode indicated by the mode dial 81 before the mode switching, without switching the operation mode (S16).

Furthermore, when the controller 50 determines that the rotation of the mode dial 81 is not related to the wireless LAN mode (that is, when the mode dial 81 receives an instruction for switching between operation modes other than the wireless LAN mode) in S12, the controller 50 causes the digital camera 10 to be operated in the operation mode after the mode switching, without allowing the liquid crystal monitor 70 to provide a display for prompting the user to give an instruction on whether to permit the switching to the operation mode indicated by the mode switching (S15).

Hereinafter, an example of an operation in which the controller 50 is shifted to the wireless LAN mode will be described. FIG. 7 is a schematic view showing a data structure in storage regions of the buffer memory 40 and the flash memory 41. As shown in FIG. 7, when the controller 50 is shifted to the wireless LAN mode, the controller 50 reads out software for wireless LAN communication previously stored in the flash memory 41, and stores the software in the buffer memory 40 (load processing). Then, the controller 50 executes the software for wireless LAN communication stored in the buffer memory 40 to execute the control in the wireless LAN mode. In the present embodiment, the operation of loading the software used for the control in the wireless LAN mode in the buffer memory 40 can be executed only when the wireless LAN mode is being activated. Thus, it is not necessary to load software for wireless LAN communication in the buffer memory 40 in operation modes other than the wireless LAN mode, so that the storage region in the buffer memory 40 can be used effectively.

In this case, there is a disadvantage in that it takes a long period of time (i.e., several seconds) from the switching to the wireless LAN mode by the mode dial 81 to the activation of the wireless LAN mode. Therefore, when the switching between the wireless LAN mode and another mode occurs frequently, the wireless LAN mode needs to be activated several times, which causes trouble in other manipulations during the switching. Consequently, the usability is degraded.

According to the present invention, when the mode dial 81 receives an instruction for switching between the wireless LAN mode and another mode, the controller 50 causes the liquid crystal monitor 70 to provide a display for prompting the user to give an instruction on whether to permit the switching to the operation mode indicated by the instruction. Thus, the operation mode is switched after the user's intention is checked. Consequently, even in the case where the manipulation for activating the wireless LAN mode is performed or the manipulation for ending the wireless LAN mode is performed due to the error of the user, the operation mode is not switched immediately. This can prevent the inconvenience in which the time-consuming processing must be executed several times for activating the wireless LAN mode. In particular, the digital camera 10 of the present embodiment receives the change in the operation mode by the mode dial 81. The mode dial 81 is provided on the top surface of the digital camera 10, so that the user may manipulate the mode dial 81 frequently without intention. Thus, in the digital camera 10 according to the present embodiment, it is particularly effective that the liquid crystal monitor 70 is caused to provide a display for prompting the user to give an instruction on whether to permit the switching of the operation mode between the wireless LAN mode and another mode so as to check the user's intention, and then, the operation mode is switched. Even if the means for selecting an operation mode is not the mode dial 81 in the present embodiment, the effectiveness is considered to be high as long as the means is a manipulation member provided on an outer side of the equipment. For example, even if the means for selecting an operation mode is a slide switch and a jog dial provided on an outer side of the equipment, the effectiveness is considered to be high.

In contrast, if the user is prompted to make a determination every time the mode dial 81 receives an instruction for switching between the operation modes other than the wireless LAN mode, the manipulation becomes complicated, which rather degrades the usability. Therefore, when the mode dial 81 receives an instruction for switching between the operation modes other than the wireless LAN mode, the controller 50 causes the digital camera to be operated in the operation mode after the mode switching without causing the liquid crystal monitor 70 to provide a display for prompting the user to give an instruction.

As the reason why it takes a long time to activate the wireless LAN mode, a load of software is illustrated; however, the reason is not limited thereto. Even in the case where the software for wireless LAN communication is previously loaded on the buffer memory 40, the step of authenticating an access point and a server is required for the wireless LAN communication, so that it takes a certain long time for the activation. Thus, confirming the user's intention when the wireless LAN mode is activated or ended is effective even in the case not using the technique of loading the above-mentioned software.

Furthermore, in the case where the mode dial 81 is switched from the state indicating another operation mode to the state indicating the wireless LAN mode, a display for prompting the user to give an instruction such as “Activate the wireless LAN mode?” is performed. After that, when the mode dial 81 is rotated further to obtain the state indicating another operation mode, the controller 50 may erase the above-mentioned screen for prompting the user to give an instruction to cause the digital camera 10 to be operated in the operation mode indicated by the mode dial 81.

Furthermore, as the reason why the operation mode is switched after the user's intention is confirmed when the mode dial 81 receives an instruction for switching between the wireless LAN mode and another mode, the prevention of the inconvenience in which it takes several times for activating the wireless LAN mode is described. However, in some cases, the prevention of the following situation may be considered as the reason: the mode is switched when the mode dial 81 is manipulated erroneously during wireless communication, with the result that wireless communication is disconnected against the user's intention

### 2-2. Shift Operation to a Wireless LAN Mode

Hereinafter, an operation during mode switching will be described by way of specific examples.

First, the operation during the shift from the operation mode (e.g., a playback mode) other than the wireless LAN mode to the wireless LAN mode will be described.

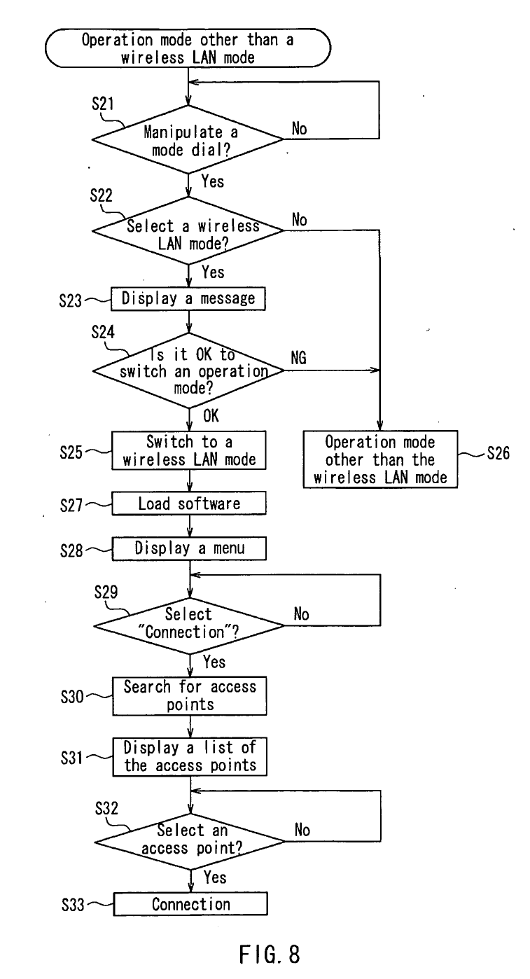

FIG. 8 is a flowchart illustrating the operation of the controller 50 during the shift from an operation mode other than the wireless LAN mode to the wireless LAN mode.

First, when the mode dial 81 selects an operation mode (e.g., a playback mode) other than the wireless LAN mode, the controller 50 monitors the rotation of the mode dial 81 to determine whether or not the mode switching has been performed (S21).

Next, when the controller 50 detects that the mode dial 81 has been rotated to perform the mode switching (YES in S21), the controller 50 determines whether or not the operation mode selected by the model dial 81 after the mode switching is a wireless LAN mode (S22).

Next, when the controller 50 determines that the mode dial 81 has selected the wireless LAN mode, the controller 50 causes the liquid crystal monitor 70 to display a determination screen (S23).

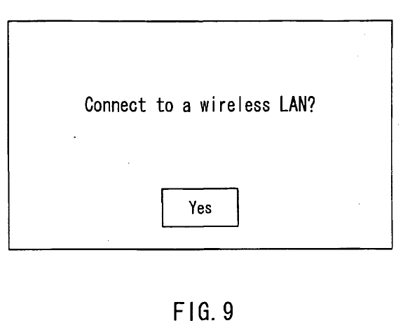

On the determination screen displayed on the liquid crystal monitor 70, the user is capable of inputting an instruction on whether to permit the switching to the operation mode selected by the mode switching of the mode dial 81. FIG. 9 is an example of the determination screen. The controller 50 causes the liquid crystal monitor 70 to display a determination screen shown in FIG. 9, and thereafter, monitors the input of an instruction for permitting the shift to the wireless LAN mode by the user. While the determination screen is displayed on the liquid crystal monitor 70 as shown in FIG. 9, the digital camera 10 has not been shifted to the wireless LAN mode and is being operated in an operation mode before the mode dial 81 is rotated (S24).

Herein, in the example shown in FIG. 9, only a display for prompting the user to give an instruction on whether to permit the shift to the wireless LAN mode is provided, and a display for prompting the user to give an instruction for not permitting the shift to the wireless LAN mode is not provided. That is, only a choice “YES” is shown as a display for prompting the user to give an instruction on whether to permit the shift to the wireless LAN mode, and a choice “NO” is not shown as a display for prompting the user to give an instruction for not permitting the shift to the wireless LAN mode. The reason for this will be described below.

The following is assumed: in the case where the mode dial 81 is set at “NET”, not only a display “YES” for prompting the user to give an instruction on whether to permit the shift to the wireless LAN mode, but also a display “NO” for prompting the user to give an instruction for not permitting the shift to the wireless LAN mode are provided. In this case, it is assumed that the user selects “NO”. Then, irrespective of the fact that the mode dial 81 is set at “NET”, the digital camera 10 is to be operated in an operation mode other than the wireless LAN mode. If there is no consistency between the operation mode indicated by the mode dial 81 and the operation mode in which the digital camera 10 actually is controlled, the user cannot exactly recognize in which operation mode the digital camera 10 is controlled currently. If such a situation occurs, the convenience of the digital camera 10 may be impaired. Then, in the example shown in FIG. 9, only a display for prompting the user to give an instruction on whether to permit the shift to the wireless LAN mode is provided, and a display for prompting the user to give an instruction for not permitting the shift to the wireless LAN mode is not provided. That is, the consistency between the operation mode indicated by the mode dial 81 and the operation in which the digital camera is controlled actually is obtained at all times.

When the manipulation portion 80 is manipulated by the user and an instruction for permitting the shift to the wireless LAN mode is input while the determination screen is displayed on the liquid crystal monitor 70 (YES in S24), the controller 50 controls each portion of the digital camera 10 so that the digital camera 10 is shifted to the wireless LAN mode (S25). As a specific method for inputting an instruction, for example, there is a method for manipulating a determination button 80c positioned at the center of the cursor button 80a shown in FIG. 3 while the determination screen shown in FIG. 9 is displayed on the liquid crystal monitor 70.

On the other hand, in the case where the mode dial 81 is rotated while the determination screen is displayed on the liquid crystal monitor 70, the controller 50 stops the display of the determination screen and shifts the digital camera 10 to the operation mode selected by the mode dial 81. For example, in the case where the mode dial 81 is rotated to select a replay mode while the determination screen shown in FIG. 9 is displayed on the liquid crystal monitor 70 (S23), the controller 50 switches the display contents of the liquid crystal monitor 70 from the determination screen to the replay mode screen (a display of an image based on image data recorded on the memory card 61, etc.). The digital camera 10 has not been shifted to the wireless LAN mode yet while the determination screen is displayed on the liquid crystal monitor 70 (S23). Therefore, when the mode dial 81 is rotated to select a replay mode, a screen in a replay mode can be displayed on the liquid crystal monitor 70 immediately.

Next, when the operation mode is shifted to the wireless LAN mode (S25), the controller 50 performs a loading operation of software (S27). A specific software loading operation has been described above with reference to FIG. 7, so that the description thereof will be omitted here.

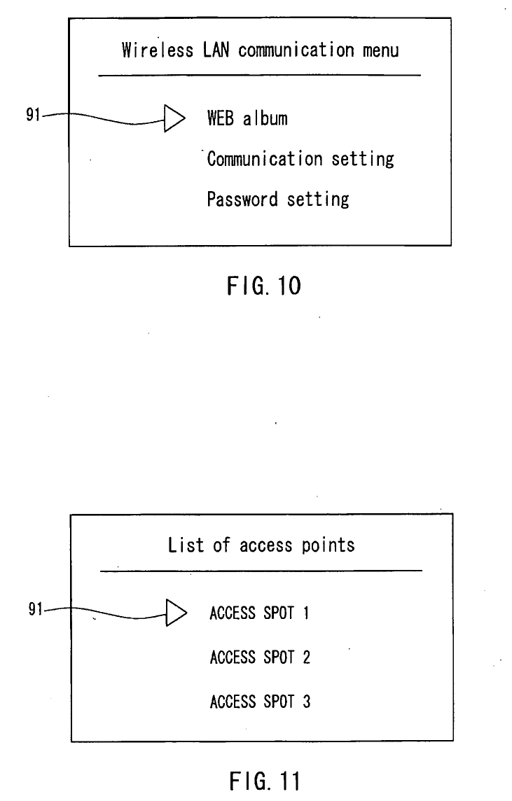

Next, when the loading of the software for wireless LAN communication is completed, the controller 50 causes the liquid crystal monitor 70 to display a menu screen. FIG. 10 shows an example of a wireless LAN communication menu screen. In the wireless LAN communication menu shown in FIG. 10, items such as a WEB album, a communication setting, and a password setting are displayed, and a desired item can be selected from them. While the wireless LAN communication menu shown in FIG. 10 is displayed on the liquid crystal monitor 70, the user presses an upward button and a downward button included in the cursor key 80a (see FIG. 2) to move a cursor 91 displayed in the screen to a desired item, and presses the determination button 80c (see FIG. 2). Thus, the user can select the desired item. In the present embodiment, the description will be made assuming that the “WEB album” is selected (S28).

Next, when the user manipulates the manipulation portion 80 to select the “WEB album” in the wireless LAN communication menu shown in FIG. 10 (YES in S29), the controller 50 refers to access point information registered in the flash memory 41 (S30). Then, the controller 50 causes the liquid crystal monitor 70 to display a list of access point names based on the access point information referred to. FIG. 11 shows a screen of a list of access point names displayed on the liquid crystal monitor 70. The display example shown in FIG. 11 shows that three pieces of access point information are registered in the flash memory (S31).

While the screen of a list shown in FIG. 11 is displayed on the liquid crystal monitor 70, the user presses an upward button and a downward button included in the cursor key 80a (see FIG. 2) to move the cursor 91 displayed in the screen to a position corresponding to a desired access point name, and presses the determination button 80c (see FIG. 2). Thus, the desired access point information can be selected. In the present embodiment, the description will be made assuming that “ACCESS SPOT 1” in an access point list is selected (YES in S32).

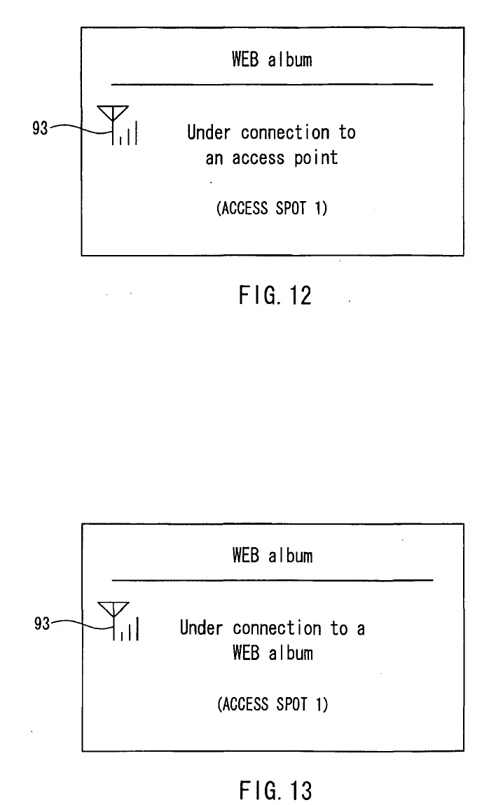

Next, when the user manipulates the manipulation portion 80 to select the “ACCESS SPOT 1” in the access point list shown in FIG. 11, the controller 50 causes the wireless LAN communication portion 90 to be connected to the wireless LAN and causes the liquid crystal monitor 70 to display a screen shown in FIG. 12. FIG. 12 shows a screen displayed at a time when the wireless LAN communication portion 90 is connected to an access point. Next, the controller 50 causes the wireless LAN communication portion 90 to be connected to the “WEB album” that is a particular region on a server or a computer via the access point. While the wireless LAN connection portion 90 is connected to the “WEB album” that is a particular region on the server or the computer via the access point, the controller 50 causes the liquid crystal monitor 70 to display a screen shown in FIG. 13.

A mark 93 shown in FIGS. 12 and 13 is displayed on a screen by the control of the controller 50 while the wireless LAN connection portion 90 is connected to the wireless LAN. More specifically, the mark 93 can notify the user visually that the digital camera 10 is connected to the wireless LAN.

2-3. Shift Operation from a Wireless LAN Mode to Another Operation Mode

Hereinafter, an operation in which the mode dial 81 is rotated while the mode dial 81 selects the wireless LAN mode to shift an operation mode to another operation mode will be described.

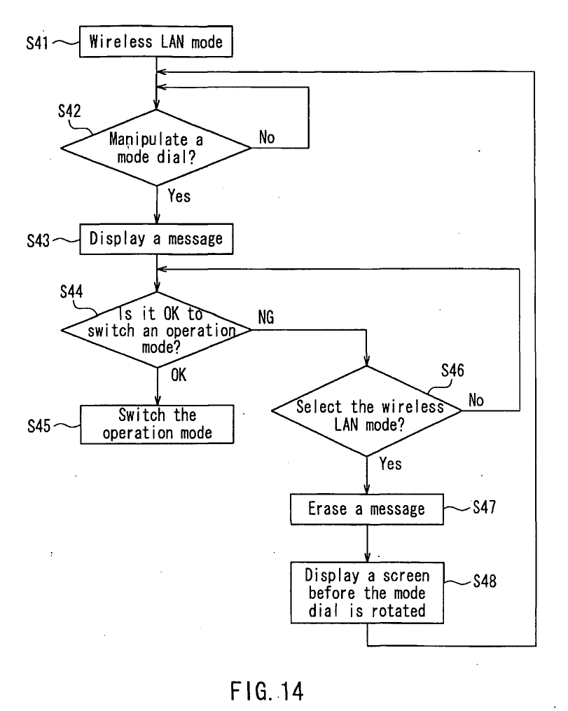

FIG. 14 is a flow of a shift operation from the wireless LAN mode to another operation mode. First, the controller 50 detects whether or not the mode dial 81 has been rotated during the operation in the wireless LAN mode (S41). The wireless LAN mode shown in S41 corresponds to the states after S25 in FIG. 8, and is not related to whether or not the wireless LAN connection portion 90 is connected to the wireless LAN actually (S42).

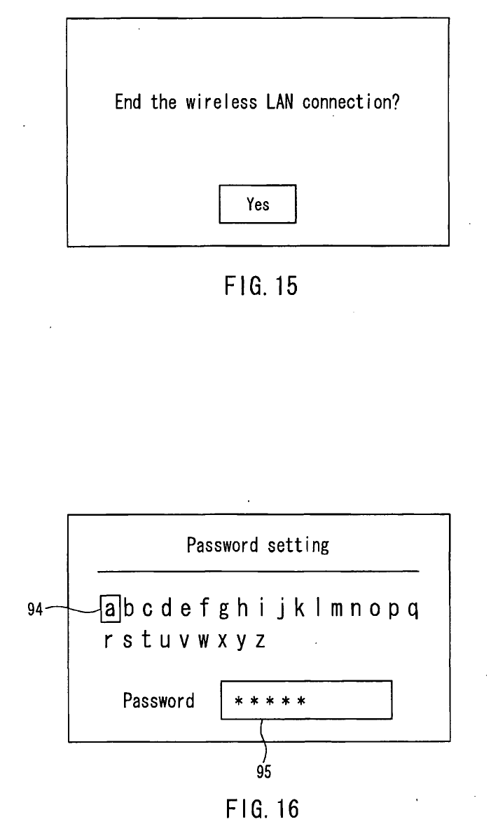

Next, when the controller 50 detects that the mode dial 81 after being rotated has selected an operation mode (for example, a replay mode) other than the wireless LAN mode, the controller 50 causes the liquid crystal monitor 70 to display a determination screen. FIG. 15 shows an example of the determination screen (S43). Herein, even in the example shown in FIG. 15, in the same way as in the example shown in FIG. 9, only a display for prompting the user to give an instruction on whether to permit the shift to an operation mode other than the wireless LAN mode is provided, and a display for prompting the user to give an instruction for not permitting the shift to an operation mode other than the wireless LAN mode is not provided for the same reason as that for the shift to the wireless LAN mode.

The controller 50 causes the liquid crystal monitor 70 to display a determination screen shown in FIG. 15, and thereafter, the controller 50 monitors the user's input of an instruction for coming out of the wireless LAN mode. Specifically, the wireless LAN mode can be ended when the determination button 80c included in the cursor button 80a is pressed, so that the controller 50 monitors the manipulation for the determination button 80c.

When the controller 50 detects that the determination button 80c has been manipulated while the liquid crystal monitor 70 displays the determination screen shown in FIG. 15 (OK in S44), the controller 50 controls each portion in the digital camera 10 so as to be shifted to the operation mode selected by the mode dial 81. At this time, the controller 50 causes the wireless LAN communication portion 90 to suspend the connection to the wireless LAN. Next, the controller 50 unloads the software for wireless LAN connection loaded in the buffer memory 40 (S45).

On the other hand, when the controller 50 detects that the mode dial 81 has been rotated to select the wireless LAN mode again while the determination screen shown in FIG. 15 is displayed on the liquid crystal monitor 70 (YES in S46), the controller 50 erases the determination screen displayed on the liquid crystal monitor 70. Due the erasure of the determination screen, the user can understand immediately that the digital camera 10 has been returned to the wireless LAN mode again, so that the user can be shifted to a subsequent manipulation quickly (S47).

Next, the controller 50 causes the liquid crystal monitor 70 to display a screen before the mode dial 81 has been rotated, and keeps the wireless LAN mode (S48).

The controller 50 causes the liquid crystal monitor 70 to continue to display the determination screen until the mode dial 81 selects the wireless LAN mode again. More specifically, the user needs to press the determination button 80c to end the wireless LAN mode or to select the wireless LAN mode again by the mode dial 81 to maintain the wireless LAN mode, after the determination screen is displayed on the liquid crystal monitor 70 (NO in S46).

### 3. Effects of an Embodiment, etc.

In the present embodiment, when the mode dial 81 is rotated, it is determined whether or not the rotation of the mode dial 81 is related to the wireless LAN mode, and in the case where the rotation of the mode dial 81 is related to the wireless LAN mode, the connection and the disconnection between the digital camera 10 and the wireless LAN is not performed immediately. Due to such a configuration, even if the mode dial 81 is rotated unexpectedly, the connection to the wireless LAN or the disconnection therefrom is not performed, so that the mode dial 81 can be manipulated immediately to shift the digital camera 10 to a desired operation mode. Thus, the ease of use can be enhanced.

In the present embodiment, a display for prompting the user to give an instruction is provided both when the digital camera 10 enters the wireless LAN mode and when the digital camera 10 comes out of the wireless LAN mode. However, the present invention is not limited thereto. For example, such a display may be provided only when the digital camera 10 enters the wireless LAN mode, and such a display may not be provided when the digital camera 10 comes out of the wireless LAN mode. “The case where the mode switching unit receives an instruction for switching between a wireless communication mode and another mode” refers to the case where the mode switching unit receives a manipulation for entering the wireless communication mode and/or the case where the mode switching unit receives a manipulation for coming out of the wireless communication mode.

Furthermore, in the present embodiment, although the digital camera 10 having a wireless LAN function is illustrated, the present invention is not limited thereto. For example, the present invention also is applicable to a digital camera or the like, on which a communication function pursuant to a Worldwide Interoperability for Microwave Access (Wi-Max) specification is mounted. The present invention also is applicable to a digital camera on which a global positioning system (GPS) connection function is mounted. That is, the present invention is applicable to an image pickup apparatus having a wireless communication function.

Furthermore, in the present embodiment, the case of entering the wireless LAN mode and the case of coming out of the wireless LAN mode are illustrated. However, the present invention is not limited thereto. For example, in the case where the present invention is applied to electronic equipment capable of receiving a television broadcast, a display for prompting the user to give an instruction on whether to permit mode switching when the electronic equipment enters a television broadcast receiving mode or comes out thereof. In such electronic equipment capable of receiving a television broadcast, it takes a certain time to activate a television broadcast receiving function. Therefore, a waiting time is generated every time a television broadcast receiving mode is turned on/off unexpectedly, which may degrade the usability. Such a problem is the same as that in the case of the wireless communication mode. That is, in the case where there is a problem in the usability, e.g., it takes a time for turning on/off a mode, the present invention is applicable with such a mode being a “particular operation mode” of the present invention.

Furthermore, in the present embodiment, in the case where the user permits the connection to the wireless LAN in S14 (FIG. 5) or S24 (FIG. 8), the digital camera 10 can be connected to the wireless LAN. In this case, the step of authenticating a password may be added to the subsequent step of S14 or S24. More specifically, after the user inputs an instruction for permitting the connection to the wireless LAN in S14 or S24, the liquid crystal monitor 70 is caused to display a password input screen, and the digital camera 11 is not allowed to be connected to the wireless LAN unless a password matched with that registered previously is input. Due to such a configuration, a malicious person can be prevented from accessing the wireless LAN via the digital camera 11 without authorization. In order to set a password, an upward key and a downward key included in the cursor key 80a (see FIG. 3) are manipulated in the wireless LAN communication menu shown in FIG. 10 to move the cursor 91 to a position corresponding to “password setting”, and the determination button 80c is pressed. When the controller 50 receives this manipulation, the controller 50 causes the liquid crystal monitor 70 to display the password setting screen shown in FIG. 16. After the password setting screen shown in FIG. 16 is displayed on the liquid crystal monitor 70, the user manipulates the cursor key 80a (see FIG. 3) to move the cursor 94 to a desired letter, and presses the determination button 80c, thereby inputting characters constituting the password one by one in a password input portion 95 (the characters displayed on the password input portion 95 are asterisk marks). When the user finishes inputting all the characters constituting the password by repeating the above input method, the user presses the determination button 80c. Thus, the setting of the password is completed. The controller 50 stores the password set based on the above-mentioned manipulation in the flash memory 41. Furthermore, the controller 50 compares the password input by the user with the password stored in the flash memory 41 in the password authentication step, and permits the connection to the wireless LAN only when both the passwords are matched with each other.

Furthermore, in the present embodiment, when the mode dial 81 is set at “NET” by the user, a display for prompting the user to give an instruction on whether to permit the shift to the wireless LAN mode is provided in S13 (FIG. 5). However, the present invention is not limited thereto. For example, in S13, the above-mentioned password input screen may be displayed instead of providing a display for prompting the user to give an instruction on whether to permit the shift to the wireless LAN mode. This is because, when there is an input of a password, the user is considered to indicate his/her intention to permit the shift to the wireless LAN mode. Due to such a configuration, the password input screen also can have a role of providing a display for prompting the user to give an instruction on whether to permit the shift to the wireless LAN mode.

Furthermore, in the present embodiment, although a digital camera is illustrated as an example of the electronic equipment of the present invention, the present invention is not limited thereto. For example, a display apparatus having a television broadcast receiving function or the like also can be applied. That is, the present invention is applicable to electronic equipment having a plurality of operation modes.

Furthermore, the mode dial 81 in the present embodiment is an example of the mode switching unit in the present invention. Furthermore, the liquid crystal monitor 70 in the present embodiment is an example of the display unit in the present invention. Furthermore, the flash memory 41 in the present embodiment is an example of the first storage unit in the present invention. Furthermore, the buffer memory 40 in the present embodiment is an example of the second storage unit in the present invention. Furthermore, the controller 50 in the present embodiment is an example of the control unit and the reading unit in the present invention.

The present invention is applicable to electronic equipment having a plurality of operation modes. More specifically, the present invention is applicable to a digital camera, a video camera, a mobile telephone terminal with a camera function, a display apparatus with a television broadcast receiving function, and the like.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An image pickup apparatus, comprising:
a rotary type or slide type mode switching unit that receives a manipulation for selecting one operation mode from a plurality of operation modes including a particular operation mode and other operation modes;
a display unit capable of displaying information for controlling the image pickup apparatus; and
a control unit that switches the operation mode of the image pickup apparatus in accordance with the manipulation received by the mode switching unit,
wherein, when the mode switching unit receives a manipulation for switching from one of the other operation modes to the particular operation mode and/or when the mode switching unit receives a manipulation for switching from the particular operation mode to one of the other operation modes, the control unit causes the display unit to provide a display for prompting a user to give an instruction on whether to permit switching of the operation mode, before the control unit switches the operation mode.

2. The image pickup apparatus according to claim 1, wherein, when the mode switching unit receives a manipulation for switching between the other operation modes, the control unit switches the operation mode of the image pickup apparatus without allowing the display unit to provide a display for prompting the user to give an instruction.

3. The image pickup apparatus according to claim 1, further comprising a receiving unit that receives an instruction of the user for permitting switching of the operation mode,
wherein, after the control unit causes the display unit to provide a display for prompting the user to give an instruction on whether to permit switching of the operation mode, the control unit causes the image pickup apparatus to be operated in an operation mode before switching of the mode switching unit until the receiving unit receives the instruction of the user.

4. The image pickup apparatus according to claim 1, wherein, when the mode switching unit receives a manipulation for switching from one of the other operation modes to the particular operation mode and/or when the mode switching unit receives a manipulation for switching from the particular operation mode to one of the other operation modes, the control unit causes the display unit to provide a display for prompting the user to give an instruction on whether to permit switching of the operation mode and prohibits the display unit from providing a display for prompting the user to give an instruction for not permitting switching of the operation mode, before switching of the operation mode.

5. The image pickup apparatus according to claim 1, wherein, when the mode switching unit receives a manipulation for switching from the particular operation mode to one of the other operation modes, the control unit causes the display unit to provide a display for prompting the user to give an instruction on whether to permit switching of the operation mode, before the control unit switches the operation mode, and
when the mode switching unit receives a manipulation for switching from one of the other operation modes to the particular operation mode while the display unit provides the display for prompting the user to give an instruction on whether to permit switching of the operation mode, the control unit erases the display on the display unit.

6. The image pickup apparatus according to claim 1, further comprising:
a first storage unit that stores a control program for controlling the particular operation mode;
a reading unit that reads the control program from the first storage unit; and
a second storage unit that is capable of storing the control program read by the reading unit and being accessible at a higher speed than that of the first storage unit,
wherein the reading unit reads the control program from the first storage unit when the control unit switches the operation mode from one of the other operation modes to the particular operation mode.

7. The image pickup apparatus according to claim 1, wherein the mode switching unit is a dial.

8. The image pickup apparatus according to claim 1, wherein the particular operation mode is a wireless communication mode.

9. Electronic equipment, comprising:
a rotary type or slide type mode switching unit that receives a manipulation for selecting one operation mode from a plurality of operation modes including a particular operation mode and other operation modes;
a display unit capable of displaying information for controlling the electronic equipment; and
a control unit that switches the operation mode of the electronic equipment in accordance with the manipulation received by the mode switching unit,
wherein, when the mode switching unit receives a manipulation for switching from one of the other operation modes to the particular operation mode and/or when the mode switching unit receives a manipulation for switching from the particular operation mode to one of the other operation modes, the control unit causes the display unit to provide a display for prompting a user to give an instruction on whether to permit switching of the operation mode, before the control unit switches the operation mode.

10. The electronic equipment according to claim 9, wherein, when the mode switching unit receives a manipulation for switching between the other operation modes, the control unit switches the operation mode of the electronic equipment without allowing the display unit to provide a display for prompting the user to give an instruction.

11. The electronic equipment according to claim 9, further comprising a receiving unit that receives an instruction of the user for permitting switching of the operation mode,
wherein, after the control unit causes the display unit to provide a display for prompting the user to give an instruction on whether to permit switching of the operation mode, the control unit causes the electronic equipment to be operated in an operation mode before switching of the mode switching unit until the receiving unit receives the instruction of the user.

12. The electronic equipment according to claim 9, wherein, when the mode switching unit receives a manipulation for switching from one of the other operation modes to the particular operation mode and/or when the mode switching unit receives a manipulation for switching from the particular operation mode to one of the other operation modes, the control unit causes the display unit to provide a display for prompting the user to give an instruction on whether to permit switching of the operation mode and prohibits the display unit from providing a display for prompting the user to give an instruction for not permitting switching of the operation mode, before switching of the operation mode.

13. The electronic equipment according to claim 9, wherein, when the mode switching unit receives a manipulation for switching from the particular operation mode to one of the other operation modes, the control unit causes the display unit to provide a display for prompting the user to give an instruction on whether to permit switching of the operation mode, before the control unit switches the operation mode, and
when the mode switching unit receives a manipulation for switching from one of the other operation modes to the particular operation mode while the display unit provides the display for prompting the user to give an instruction on whether to permit switching of the operation mode, the control unit erases the display on the display unit.

14. The electronic equipment according to claim 9, further comprising:
a first storage unit that stores a control program for controlling the particular operation mode;
a reading unit that reads the control program from the first storage unit; and
a second storage unit that is capable of storing the control program read by the reading unit and being accessible at a higher speed than that of the first storage unit,
wherein the reading unit reads the control program from the first storage unit when the control unit switches the operation mode from one of the other operation modes to the particular operation mode.

15. The electronic equipment according to claim 9, wherein the mode switching unit is a dial.

16. The electronic equipment according to claim 9, wherein the particular operation mode is a wireless communication mode.
